(19) United States
(12) Patent Application Publication
(10) Pub. No.: US 2014/0026572 A1
(43) Pub. Date: Jan. 30, 2014

(54) SYSTEM AND METHOD FOR CAPTURING CARBON DIOXIDE FROM SHIFTED SYNGAS

(71) Applicants: Ashok Kumar Anand, Schenectady, NY (US); Thirumala Reddy Nagarjuna Reddy, Bangalore (IN)

(72) Inventors: Ashok Kumar Anand, Schenectady, NY (US); Thirumala Reddy Nagarjuna Reddy, Bangalore (IN)

(73) Assignee: General Electric Company, Schenectady, NY (US)

(21) Appl. No.: 13/557,604

(22) Filed: Jul. 25, 2012

(51) Int. Cl. B01D 53/62; B01D 53/02; F01K 27/00

(52) U.S. Cl. 60/643; 96/146; 96/130; 95/139; 422/168

(57) ABSTRACT

A system for capturing carbon dioxide from a shifted syngas is disclosed. The system may generally include a solid sorbent configured to absorb carbon dioxide at a first temperature and release carbon dioxide at a second temperature. In addition, the system may include an absorption chamber configured to receive the shifted syngas at the first temperature and a regeneration chamber separate from the absorption chamber. The regeneration chamber may be maintained at the second temperature. The solid sorbent may be cycled between the absorption chamber and the regeneration chamber such that carbon dioxide from the shifted syngas is absorbed within the absorption chamber to produce a decarbonized fuel gas and released within the regeneration chamber to produce a carbon dioxide stream.

### STATEMENT REGARDING FEDERALLY SPONSORED RESEARCH

This invention was made with Government support under Contract No. DE-FC26-05NY42643, awarded by the Department of Energy. The Government may have certain rights in this invention.

### FIELD OF THE INVENTION

The present subject matter relates generally to a system and method for carbon dioxide capture and, more particularly, to a high temperature system and method for capturing carbon dioxide from the shifted syngas used within a power plant.

### BACKGROUND OF THE INVENTION

As society becomes more conscious of the potential for global warming, attempts have been made to reduce the amount of carbon dioxide (CO₂) emitted into the atmosphere. Specifically, in fossil fuel burning power plants, attempts have been made to capture CO₂ at various points in time during the operating cycle of the various applications and systems forming the power plant. For example, various systems have been developed for Integrated Gasification Combined Cycle (IGCC) power plants that utilize liquid-based solvents to capture and remove CO₂ from the synthesis gas (syngas) produced by the gasification process prior to such syngas being delivered to the power block for subsequent combustion. However, these conventional systems require that the pressure and temperature be reduced significantly to allow for CO₂ captured by the liquid-based solvent to be released for disposal. For example, a refrigeration system is typically required to cool the syngas conditioning solvent to an appropriate temperature for CO₂ capture, which necessitates large amounts of auxiliary power. As a result, a significant portion of the power generated by the power plant is used to operate the refrigeration system, thereby reducing the plant's overall power output and power conversion efficiency. Moreover, by requiring a reduction in the temperature and pressure of the syngas, power plants incorporating conventional CO₂ capture systems often require temperature conditioning of the decarbonized fuel gas prior to it being supplied to the power block, thereby further reducing the overall efficiency of the power plant.

Accordingly, a system and method for capturing carbon dioxide within a power plant at high temperatures and/or pressures would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a system for capturing carbon dioxide from a shifted syngas. The system may generally include a solid sorbent configured to absorb carbon dioxide at a first temperature and release carbon dioxide at a second temperature. In addition, the system may include an absorption chamber configured to receive the shifted syngas at the first temperature and a regeneration chamber separate from the absorption chamber. The regeneration chamber may be maintained at the second temperature. The solid sorbent may be cycled between the absorption chamber and the regeneration chamber such that carbon dioxide from the shifted syngas is absorbed within the absorption chamber to produce a decarbonized fuel gas and released within the regeneration chamber to produce a carbon dioxide stream.

In another aspect, the present subject matter is directed to a power plant including a gasifier configured to produce a raw syngas and a shift reactor downstream of the gasifier. The shift reactor may be configured to convert the raw syngas into a shifted syngas including hydrogen and carbon dioxide. The power plant may also include a carbon dioxide capture system downstream of the shift reactor. The carbon dioxide capture system may generally include a solid sorbent configured to absorb carbon dioxide at a first temperature and release carbon dioxide at a second temperature. In addition, the carbon dioxide capture system may include an absorption chamber configured to receive the shifted syngas at the first temperature and a regeneration chamber separate from the absorption chamber. The regeneration chamber may be maintained at the second temperature. The solid sorbent may be cycled between the absorption chamber and the regeneration chamber such that carbon dioxide from the shifted syngas is absorbed within the absorption chamber to produce a decarbonized fuel gas and released within the regeneration chamber to produce a carbon dioxide stream.

In a further aspect, the present subject matter is directed to a method for capturing carbon dioxide from a shifted syngas. The method may generally include cycling a solid sorbent between an absorption chamber and a regeneration chamber, the solid sorbent being configured to absorb carbon dioxide at a first temperature and release carbon dioxide at a second temperature, supplying shifted syngas into the absorption chamber at the first temperature such that the solid sorbent absorbs carbon dioxide from the shifted syngas as the solid sorbent is cycled through the absorption chamber to produce a decarbonized fuel gas and heating the solid sorbent to the second temperature as the solid sorbent is cycled through the regeneration chamber such that the solid sorbent releases the carbon dioxide to produce a carbon dioxide stream.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a simplified, schematic view of one embodiment of a power plant including a carbon dioxide capture system;

FIG. 2 illustrates a detailed, schematic view of one embodiment of the power plant shown in FIG. 1; and

FIG. 3 illustrates a detailed, schematic view of another embodiment of the power plant shown in FIG. 1.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to a system and method for capturing carbon dioxide (CO₂) from the shifted syngas used within a power plant. Specifically, in several embodiments, the CO₂ capture system may include a solid sorbent configured to be cycled between separate absorption and regeneration chambers positioned downstream of the shift reactor(s) of the power plant. The solid sorbent may, for example, comprise a ceramic material or any other high temperature catalyst configured to absorb carbon dioxide from the shifted syngas at a first, relatively high temperature and release such carbon dioxide at a second, higher temperature. Such high temperature absorption and regeneration may generally allow for the CO₂ to be captured without any loss of pressure within the power plant.

As will be apparent from the description provided below, the disclosed high temperature and high pressure CO₂ capture system may significantly improve the overall efficiency of a power plant. Specifically, the system may be capable of producing a decarbonized fuel gas that does not require further temperature conditioning and/or pressurization. In addition, the CO₂ capture system may be capable of operating without the need for expensive refrigeration systems.

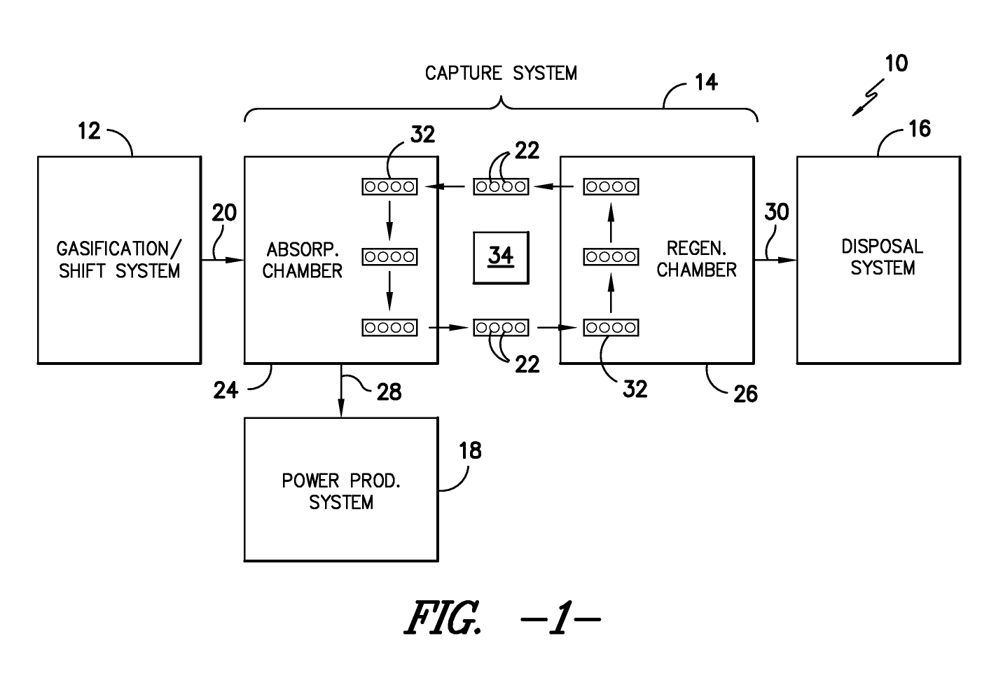

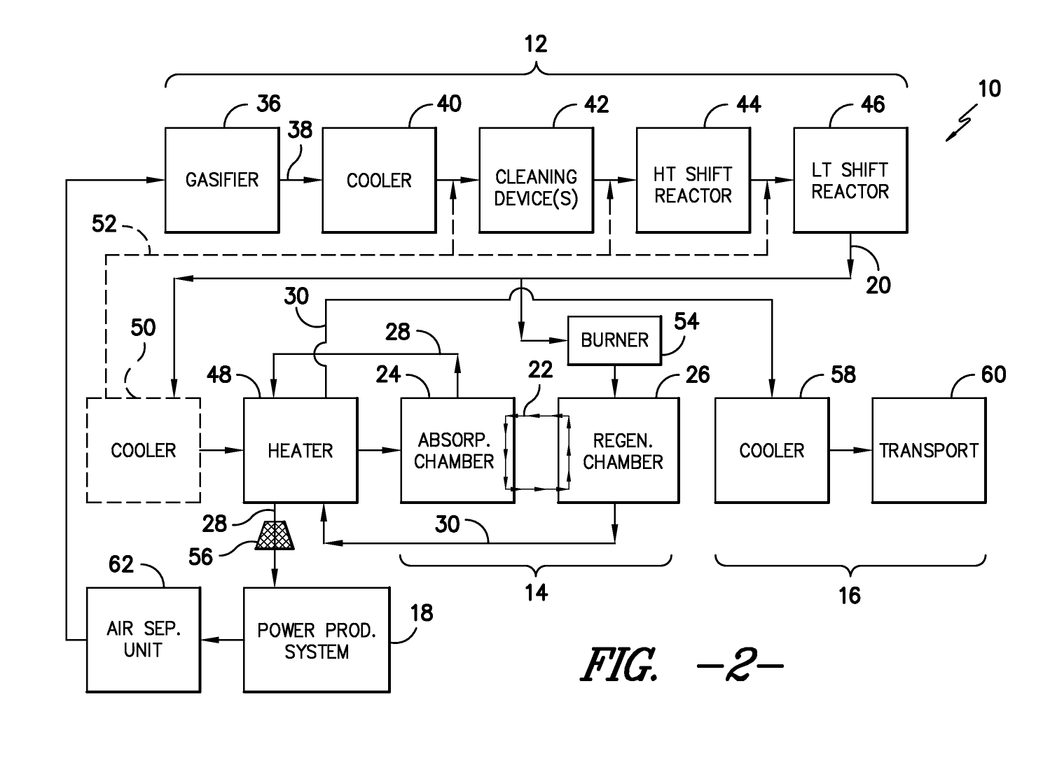

Referring now to FIG. 1, a simplified, schematic view of one embodiment of a power plant 10 is illustrated in accordance with aspects of the present subject matter. As shown, the power plant 10 generally includes a gasification/shift system 12, a CO₂ capture system 14, a CO₂ disposal system 16 and a power production system 18. In general, the gasification/shift system 12 may be configured to produce a shifted synthesis gas (syngas). For example, as will be described below with reference to FIG. 2, the gasification/shift system 12 may include a gasifier 36 (FIG. 2) configured to convert a hydrocarbon feedstock, with water/steam and air/oxygen, into a raw syngas 38 (FIG. 2). This raw syngas 38 may then be cleaned using one or more cleaning devices 42 (FIG. 2) and reacted using one or more shift reactors 44, 46 (FIG. 2) to produce a clean, shifted syngas 20 comprised primarily of hydrogen (H₂) and carbon dioxide (CO₂).

The shifted syngas 20 may then be directed to the CO₂ capture system in order to capture and remove the CO₂ contained therein. As shown in FIG. 1, the CO₂ capture system may generally include a solid sorbent 22 configured to be cycled between an absorption chamber 24 and a regeneration chamber 26. In general, the solid sorbent 22 may be configured to absorb CO₂ from the shifted syngas 20 as the sorbent 22 is transferred through the absorption chamber 24, thereby producing a stream of decarbonized fuel gas 28 (i.e., a hydrogen rich fuel gas) exiting the absorption chamber 24. The absorbed CO₂ may then be released by the solid sorbent 22 as it is transferred through the regeneration chamber 26, thereby producing a CO₂ stream 30 exiting the regeneration chamber 26. Thus, by cycling the solid sorbent 22 between the absorption and regeneration chambers 24, 26, the sorbent 22 may continuously capture CO₂ from the shifted syngas 20 and release such CO₂ within the regeneration chamber 26. The decarbonized fuel gas 28 may then be directed to the power production system 18 (e.g., a combined cycle power system) to be used for generating power while the CO₂ stream 30 may be directed to the CO₂ disposal system 16 for disposal thereof.

In general, the solid sorbent 22 used within the CO₂ capture system 14 may comprise any suitable solid, regenerable material that is capable of absorbing and releasing CO₂. However, in several embodiments, the solid sorbent 22 may be selected based on its ability to absorb and regenerate CO₂ at high temperatures. For example, the solid sorbent 22 may comprise a ceramic material, such as lithium silicate, calcium oxide, magnesium oxide and/or the like, and/or any other suitable high temperature catalyst (including mixtures and/or combinations of high temperature catalysts) that is capable of absorbing and releasing CO₂ at temperatures at or above about 800° F. Specifically, in one embodiment, the solid sorbent 22 may be configured to absorb CO₂ at a first temperature ranging from about 800° F. to about 1300° F., such as from about 900° F. to about 1250° F. or from about 1050° F. to about 1250° F. and all other subranges therebetween, and release CO₂ at a second temperature above 1300° F., such as at a temperature ranging from greater than 1300° F. to about 1500° F. or from about 1350° F. to about 1500° F. and all other subranges therebetween. In such an embodiment, the absorption chamber 24 may be configured to receive the shifted syngas 20 at the first temperature (e.g., within a temperature range of about 800° F. to about 1300° F.) to allow the sorbent 22 to absorb CO₂ from the syngas 20 as it is transferred through the absorption chamber 24. Similarly, the regeneration chamber 26 may be maintained at the second temperature (e.g., at a temperature above 1300° F.) to allow the sorbent 22 to release the CO₂ as it is transferred through the regeneration chamber 26.

It should be appreciated that the solid sorbent 22 may generally be formed into any suitable shape and/or object that allows it to capture CO₂ from the shifted syngas 20. For example, in several embodiments, the solid sorbent 22 may be formed into relatively small balls or pellets in order to increase the exposed surface area of the sorbent 22, thereby increasing its effectiveness to capture CO₂. However, in other embodiments, the solid sorbent 22 may be configured to have any other suitable form that allows it to effectively capture CO₂ from the shifted syngas 20.

In addition, it should be appreciated that the solid sorbent 22 may be cycled between the absorption and regeneration chambers 24, 26 using any suitable means known in the art. For example, as shown in FIG. 1, in one embodiment, the solid sorbent 22 may be placed in beds 32 configured to be cycled between the chambers 24, 26 using a suitable transfer mechanism 34, such as a closed-loop conveyor system. In such an embodiment, the absorption chamber 24 and/or the regeneration chamber 26 may, for example, be configured as silo-type structures to allow the beds 32 of solid sorbent 22 to be transferred vertically along the length of each chamber 24, 26 (e.g., from top-to-bottom or from bottom-to-top). For instance, the shifted syngas 20 may, in one embodiment, be injected onto the bottom of the absorption chamber 24 while the solid sorbent 22 is transferred into the absorption chamber 24 at its top. Thus, as the shifted syngas 20 flows upward within the absorption chamber 24, the solid sorbent 22 may be transferred downward in the counter-current direction in order to absorb CO₂ from the syngas 20 as it flows past the sorbent 22. The decarbonized fuel gas 28 exiting the top of the absorption chamber 24 may then be directed to the power production system 18. Additionally, the solid sorbent 22 exiting the bottom of the absorption chamber 24 may then be transferred into the bottom of the regeneration chamber 26 and cycled upward as it releases CO₂ into the chamber 26. The CO₂ stream 30 exiting the top of the regeneration chamber 26 may then be directed to the CO₂ disposal system 16.

It should be appreciated that, although the CO₂ capture system 14 is shown in FIG. 1 as including a single closed-loop for cycling solid sorbent 22 between the absorption and regeneration chambers 24, 26, the CO₂ capture system 14 may generally include any number of closed-loops (including separate loops in parallel or series) for cycling the solid sorbent 22.

Referring now to FIG. 2, a detailed, schematic view of one embodiment of the power plant 10 shown in FIG. 1 is illustrated is accordance with aspects of the present subject matter. As shown, the power plant 10 may include a gasifier 36 configured to transform a hydrocarbon feedstock into a raw syngas 38 via a gasification process. As is generally understood, the gasification process is a partial oxidation process wherein hydrocarbon feedstock, such as coal, is mixed with air/oxygen and water/steam within the gasifier 36 at a high pressure and heat. The resulting chemical reactions produce both H₂ and carbon monoxide (CO), the primary components of raw syngas 38.

The raw syngas 38 may then be directed into a syngas cooler 40 (e.g., any suitable heat exchanger) configured to reduce the temperature of the syngas 28. For example, the temperature of the syngas 38 exiting the gasifier 36 may often be around 2400° F. As a result, the syngas cooler 40 may be used to cool the syngas 38 to a suitable temperature for subsequent processing of the syngas 38 by the downstream components of the power plant 10. For example, in one embodiment, the syngas cooler 40 may be utilized to reduce the temperature of the raw syngas 38 to less than about 1250° F.

In addition, the power plant 10 may also include one or more cleaning devices 42 configured to remove one or more undesirable constituents of the raw syngas 38. For example, as shown in FIG. 2, in one embodiment, the cleaning device(s) 42 may be positioned directly downstream of the syngas cooler 40. In general, the cleaning device(s) 42 may be configured to perform any suitable syngas cleaning operation/process know in the art. For example, in one embodiment, the cleaning device(s) 42 may comprise one or more sulfur removal devices for removing sulfur from the raw syngas 38 (e.g., by using a direct sulfur removal process and/or the like). In another embodiment, the cleaning device(s) 42 may include one or more scrubbers configured to remove solid impurities from the syngas 38.

Moreover, as shown in FIG. 1, the power plant may also include one or more shift reactors 44, 46 disposed downstream of the cleaning device(s) 42 for converting the raw syngas 38 into a shifted syngas 20. As is generally understood, the shift reactor(s) 44, 46 may be configured to perform a water gas shift reaction, wherein the CO contained within the raw syngas 38 is reacted with steam to produce H₂ and CO₂. In several embodiments, a multi-stage shift reaction may be performed. For example, as shown in FIG. 2, the power plant 10 may include a high temperature shift reactor 44 for performing a high temperature shift reaction (e.g., at temperatures above about 600° F.) and a low temperature shift rector 46 for performing a low temperature shift reaction (e.g., at temperatures ranging from about 200° F. to about 400° F.).

In several embodiments, the shifted syngas 20 produced by the shift reactor(s) 44, 46 may then be directed to a syngas heater 48 (e.g., a regenerative heat exchanger) positioned upstream of the CO₂ capture system 14. The syngas heater 48 may generally be configured to increase the temperature of the shifted syngas 20 to a suitable processing temperature for removing CO₂ from the syngas 20. For example, as will be described below, in a particular embodiment of the present subject matter, the syngas heater 48 may be configured to heat the shifted syngas 20 to a temperature ranging from about 800° F. to about 1050° F.

Additionally, as shown in FIG. 2, the power plant may optionally include a cooler 50 (e.g., a low temperature syngas cooler or any other suitable heat exchanger) positioned between the shift reactor(s) 44, 46 and the syngas heater 48. In general, the cooler 50 may be configured to provide a supply of cooling water 52 for reducing the temperature of the syngas at various upstream locations. For instance, as shown in FIG.2, the cooling water 52 supplied from the cooler 50 may be mixed with the syngas prior to it being processed by various upstream components of the power plant 10 (e.g., the cleaning device(s) 42, the high temperature shift reactor 44 and/or the low temperature shift reactor 44).

Referring still to FIG. 2, the shifted syngas 20 exiting the syngas heater 48 may then be delivered to the CO₂ capture system 14. Specifically, the shifted syngas 20 may be directed into the absorption chamber 24 of the CO₂ capture system 14 such that the solid sorbent 22 transferred through the chamber 24 may absorb the CO₂ contained within the syngas 20. As indicated above, in several embodiments, the solid sorbent 22 may be chosen such that it is capable of absorbing CO₂ at a first temperature ranging from about 800° F. to about 1300° F. Thus, in one embodiment, the syngas heater 48 may be configured to heat the shifted syngas 20 to a temperature within such temperature range to permit the capture of CO₂ by the solid sorbent 22. However, it should be readily appreciated by those of ordinary skill in the art that the absorption process is exothermic in nature. As such, it may not be necessary to heat the shifted syngas 20 to the top end of the temperature range. For instance, in one embodiment, the syngas heater 48 may be configured to heat the shifted syngas to a temperature ranging from about 800° F. to about 1050° F. Thus, the syngas 20 may continue to be heated within the absorption chamber 24 as the absorption process occurs without exceeding the threshold temperature (e.g., around 1300° F.) at which the solid sorbent 22 transitions from absorbing CO₂ to releasing CO₂.

Additionally, as indicated above, in several embodiments, the solid sorbent 22 may be configured to release the CO₂ absorbed from the shifted syngas 20 at a second temperature exceeding 1300° F. Thus, in one embodiment, the power plant 10 may include a burner 54 (e.g., any suitable combustor) associated with the regeneration chamber 26 that is configured to heat the regeneration chamber 26 (and, thus, the solid sorbent 22) to a suitable temperature for releasing the absorbed CO₂. For example, as shown in FIG. 2, a portion of the shifted syngas 20 generated by the shift reactor(s) 44, 46 may be diverted to the burner 54 and subsequently mixed with air/oxygen and combusted, thereby allowing the solid sorbent 22 to be sufficiently heated within the regeneration chamber 26 to the second temperature (e.g., a temperature ranging from about 1350° F. to about 1500° F.).

As shown in FIG. 2, the decarbonized fuel gas 28 exiting the CO₂ capture system 14 may be directed to the power production system 18 of the power plant 10 for use in generating power. It should be appreciated that power production system 18 may generally comprise any suitable power system known in the art that is capable of producing power using decarbonized fuel gas 28. For example, in one embodiment, the power production system 18 may comprise a combined cycle power system having one or more gas turbines, one or more steam generators and one or more stream turbines operating in combination to generate power. In other embodiments, the power production system 18 may comprise a gas turbine system, a steam turbine system and/or any other suitable power system.

Additionally, as shown in FIG. 2, in one embodiment, the decarbonized fuel gas 28 may be directed through the syngas heater 48 prior to being supplied to the power production system 18 to permit heat from the decarbonized fuel gas 28 to be captured for use in heating the shifted syngas 20. For example, the decarbonized fuel gas 28 exiting the CO₂ capture system 14 may be at a temperature ranging from about 1200° F. to about 1300° F. whereas the shifted syngas 20 entering the syngas heater 48 may be at a temperature ranging from about 500° F. to about 600° F. Thus, the decarbonized fuel gas 28 may be used for regenerative heat recovery, thereby increasing the overall efficiency of the power plant 10.

Moreover, in several embodiments, the decarbonized fuel gas 28 may also be directed through a fuel expander 56 positioned upstream of the power production system 18. As is generally understood, the fuel expander 56 may be utilized to reduce the pressure of the decarbonized fuel gas 28 to the level required by one or more components of the power production system 18 (e.g., a gas turbine). The energy captured from reducing the pressure of the decarbonized fuel gas 28 may then be utilized to drive a load (e.g., a generator or other suitable equipment).

Referring still to FIG. 2, as indicated above, the CO₂ stream 30 exiting the regeneration chamber 26 may be directed to the CO₂ disposal system 16 of the power plant 10. In general, the disposal system 16 may comprise any suitable system known in the art for storing and/or disposing of sequestered CO₂. For example, as shown in FIG. 2, the disposal system 16 may include a cooler 58 for reducing the temperature of the CO₂ stream 30 derived from the CO₂ capture system 14. In addition, the disposal system 16 may include a transport device 60 (e.g., a pipeline) for transporting the CO₂ stream 30 to a suitable storage location (e.g., an underground or deep sea storage location).

Moreover, as shown in FIG. 2, in addition to the decarbonized fuel gas 28 or as an alternative thereto, the CO₂ stream 30 may be directed through the syngas heater 48 prior to being supplied to the disposal system 18 to allow heat from the CO₂ stream 30 to be extracted for use in heating the shifted syngas 20. For example, the CO₂ stream 30 produced by the CO₂ capture system 14 may be at a temperature ranging from about 1350° F. to about 1400° F. while, as indicated above, the shifted syngas 20 entering the syngas heater 48 may be at a temperature ranging from about 500° F. to about 600° F. Thus, the CO₂ stream 30 may be used for regenerative heat recovery, thereby increasing the overall efficiency of the power plant 10.

In addition, the power plant 10 may also include an air separation unit 62. As is generally understood, the air separation unit 62 may be configured to receive compressed air from a compressor of the power production system 18 (or an auxiliary compressor) and divide such air into separate flows of oxygen and a gas by-product. The oxygen flow may then be directed to the gasifier 36 for use in producing raw syngas 38.

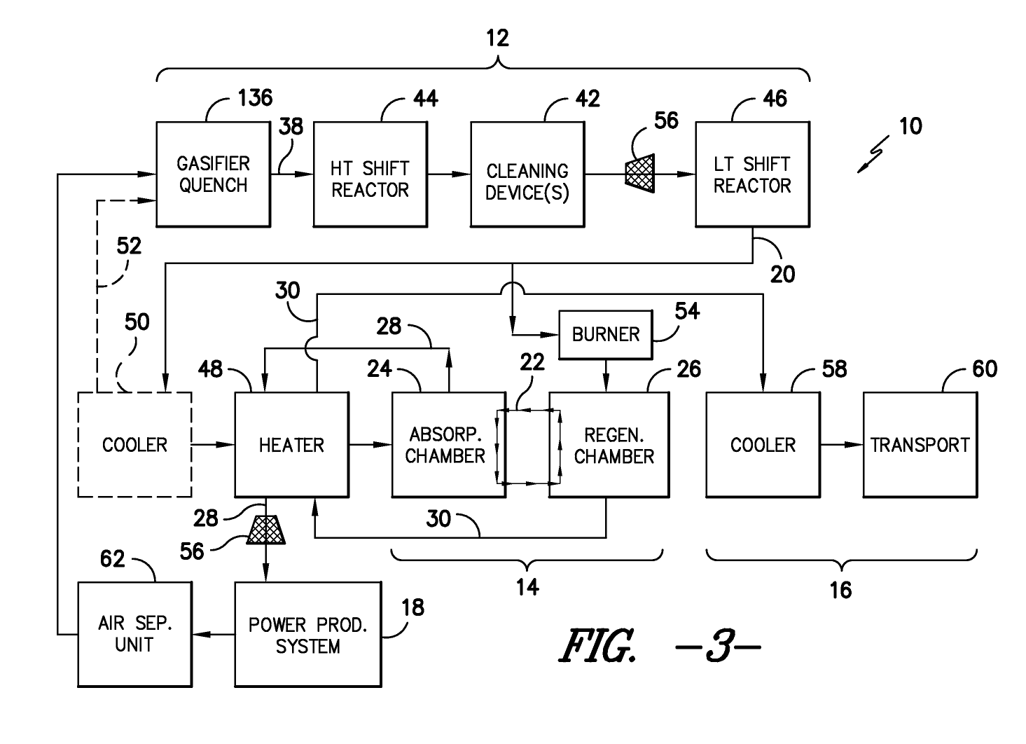

Referring now to FIG. 3, a detailed, schematic view of another embodiment of the power plant 10 shown in FIG. 1 is illustrated is accordance with aspects of the present subject matter. In general, the power plant 10 may include many and/or all of the same components as described above with reference to FIG. 2. However, as shown in FIG. 3, instead of including a syngas cooler 40 directly downstream of the gasifier 36, the power plant 10 includes a gasifier 136 including a quench chamber or other cooling system integrated therein. In such an embodiment, cooling water 52 from the syngas cooler 50 positioned downstream of the low temperature shift reactor 46 may be supplied to the gasifier 136 for quenching the raw syngas 38. As such, the syngas 38 exiting the gasifier 136 may be at a suitable temperature for subsequent processing by the downstream components of the power plant 10.

Additionally, as shown in FIG. 3, instead of being positioned upstream of the shift reactor(s) 44, 46, the cleaning device(s) 42 may, in one embodiment, be positioned between the high and low temperature shift reactors 44, 46. Such a configuration may allow for various high temperature cleaning operations/processes to be performed. For example, the high temperature reaction occurring within the high temperature shift reactor 44 may serve as an enabler for using the cleaning device(s) 42 to perform a high temperature direct sulfur removal process.

Moreover, as shown in FIG. 3, in addition to having a fuel expander 56 directly upstream of the power production system 18 or as alternative thereto, a fuel expander 56 may be positioned upstream of the syngas heater 48 (e.g., by being positioned between the cleaning device(s) 42 and the low temperature shift reactor 46) to allow for the capture of energy from the flow of syngas.

It should be appreciated that, as indicated above, the present subject matter is also directed to a method for capturing CO₂ from shifted syngas 20. In one embodiment, the method may include cycling a solid sorbent 22 between an absorption chamber 24 and a regeneration chamber 26, wherein the solid sorbent 22 is configured to absorb CO₂ at a first temperature and release CO₂ at a second temperature. In addition, the method may include supplying shifted syngas 20 into the absorption chamber 24 at the first temperature such that the solid sorbent 22 absorbs CO₂ from the shifted syngas 20 as the it is cycled through the absorption chamber 24 to produce a decarbonized fuel gas 28. The method may also include heating the solid sorbent 22 to the second temperature as the sorbent 22 is cycled through the regeneration chamber 24 such that it releases CO₂ to produce a carbon dioxide stream 30.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A system for capturing carbon dioxide from a shifted syngas, the system comprising:
a solid sorbent configured to absorb carbon dioxide at a first temperature and release carbon dioxide at a second temperature;
an absorption chamber configured to receive the shifted syngas at the first temperature; and
a regeneration chamber separate from the absorption chamber, the regeneration chamber being maintained at the second temperature,
wherein the solid sorbent is cycled between the absorption chamber and the regeneration chamber such that carbon dioxide from the shifted syngas is absorbed within the absorption chamber to produce a decarbonized fuel gas and released within the regeneration chamber to produce a carbon dioxide stream.

2. The system of claim 1, wherein the solid sorbent comprises a high temperature ceramic catalyst.

3. The system of claim 2, wherein the high temperature ceramic catalyst comprises at least one of lithium silicate, calcium oxide or magnesium oxide.

4. The system of claim 1, wherein the first temperature ranges from about 800° F. to about 1300° F.

5. The system of claim 1, wherein the second temperature ranges from about 1350° F. to about 1500° F.

6. The system of claim 1, wherein the solid sorbent is placed in beds configured to be cycled between the absorption chamber and the regeneration chamber.

7. A power plant comprising:
a gasifier configured to produce a raw syngas;
a shift reactor downstream of the gasifier, the shift reactor configured to convert the raw syngas into a shifted syngas including hydrogen and carbon dioxide; and
a carbon dioxide capture system downstream of the shift reactor, the carbon dioxide capture system comprising:
a solid sorbent configured to absorb carbon dioxide at a first temperature and release carbon dioxide at a second temperature;
an absorption chamber configured to receive the shifted syngas at the first temperature; and
a regeneration chamber separate from the absorption chamber, the regeneration chamber being maintained at the second temperature,
wherein the solid sorbent is cycled between the absorption chamber and the regeneration chamber such that carbon dioxide from the shifted syngas is absorbed within the absorption chamber to produce a decarbonized fuel gas and released within the regeneration chamber to produce a carbon dioxide stream.

8. The power plant of claim 7, further comprising a heater positioned downstream of the shift reactor and upstream of the carbon dioxide capture system, the heater configured to heat the shifted gas to the first temperature.

9. The power plant of claim 8, wherein at least one of the decarbonized fuel gas exiting the absorption chamber or the carbon dioxide stream exiting the regeneration chamber is directed through a portion of the heater.

10. The power plant of claim 7, wherein the decarbonized fuel gas exiting the absorption chamber is directed to a power production system.

11. The power plant of claim 10, wherein the power production system comprises a combined cycle power system.

12. The power plant claim 7, wherein the solid sorbent comprises a high temperature ceramic catalyst.

13. The power plant of claim 12, wherein the high temperature ceramic catalyst comprises at least one of lithium silicate, calcium oxide or magnesium oxide.

14. The power plant of claim 7, wherein the first temperature ranges from about 800° F. to about 1300° F.

15. The power plant of claim 7, wherein the second temperature ranges from about 1350° F. to about 1500° F.

16. The power plant of claim 7, wherein the solid sorbent is placed in beds configured to be cycled between the absorption chamber and the regeneration chamber.

17. The power plant of claim 7, further comprising a burner associated with the regeneration chamber, the burner being configured to maintain the regeneration chamber at the second temperature.

18. A method for capturing carbon dioxide from a shifted syngas, the method comprising:
cycling a solid sorbent between an absorption chamber and a regeneration chamber, the solid sorbent being configured to absorb carbon dioxide at a first temperature and release carbon dioxide at a second temperature;
supplying shifted syngas into the absorption chamber at the first temperature such that the solid sorbent absorbs carbon dioxide from the shifted syngas as the solid sorbent is cycled through the absorption chamber to produce a decarbonized fuel gas; and
heating the solid sorbent to the second temperature as the solid sorbent is cycled through the regeneration chamber such that the solid sorbent releases the carbon dioxide to produce a carbon dioxide stream.

19. The method of claim 18, further comprising heating the shifted syngas to the first temperature with a heater positioned upstream of the absorption chamber.

20. The method of claim 19, further comprising directing at least one of the decarbonized fuel gas or the carbon dioxide stream through the heater.
